(19) United States
(12) Patent Application Publication
(10) Pub. No.: US 2015/0040359 A1
(43) Pub. Date: Feb. 12, 2015

(54) Tensioning Assembly

(71) Applicant: USA Products Group Inc., Lodi, CA (US)

(72) Inventor: Raymond S. Brown, Modesto, CA (US)

(73) Assignee: USA Products Group Inc., Lodi, CA (US)

(21) Appl. No.: 13/964,063

(22) Filed: Aug. 10, 2013

(51) Int. Cl. B60P 7/08; B60P 7/06; B65B 13/02

(52) U.S. Cl. CPC B60P 7/0846; B60P 7/0861; B65B 13/02; B60P 7/06
USPC 24/68 CD; 74/425

(57) ABSTRACT

A tensioning assembly comprising a worm gear having a core and a thread design formed on the core, wherein the core has a catenoidal shape, is disclosed herein.

### BACKGROUND

The present disclosure relates generally to a tensioning assembly, and more particularly to a tensioning assembly having, among other things, a relatively more efficient, adjustable, and compact gear assembly.

Modern tensioning, tie down, or pulley assemblies including ratchet buckles, turn buckles, cam buckles, over-center buckles, winches, and similar devices used to secure cargo are usually of two types, specifically, cam buckle or ratching style technologies.

A typical ratchet assembly includes a rotatable hub with a plurality of outwardly-extending teeth for engagement with a spring-loaded pawl. A terminal end of the ratchet assembly is anchored to a first point. As the spool is rotated in one direction, a line, such as a flat webbing attached to a second point is wrapped around the hub to apply a tension to the line. As the hub rotates, the pawl incrementally engages the teeth to prevent the hub from rotating in the opposite direction due to the tension from the line.

Cam buckle assembly technology requires the same method of line installation as the ratcheting type device, but differs in that the cam buckle is depressed to open the teeth of the assembly while manual tension in applied to pull the webbing through the cam buckle. The webbing is typically held in place by a back pressure on the closed teeth of the cam buckle.

Although tensioning assemblies are well known, it would be desirable to provide an improved tensioning assembly having, among other things, a gear assembly for applying a tension to a line in a relatively more efficient, adjustable, and compact manner.

### SUMMARY

For purposes of summarizing the disclosure, exemplary concepts have been described herein. It is to be understood that not necessarily all such concepts may be achieved in accordance with any particular embodiment. Thus, for example, those skilled in the art will recognize that embodiments may be carried out in a manner that achieves or optimizes one concept as taught herein without necessarily achieving other concepts as may be taught or suggested herein.

In one embodiment, a tensioning assembly comprising a worm gear having a core and a thread design formed on the core, wherein the core has a catenoidal shape.

In another embodiment, a tensioning assembly comprising a frame having a first end and a second end opposite the first end; and a strap connected to the first end, wherein the second end is configured to interchangeable accept a device to secure the second end.

These and other embodiments will become apparent to those skilled in the art from the following detailed description of the various embodiments having reference to the attached figures, the disclosure not being limited to any particular embodiment.

### BRIEF DESCRIPTION OF THE DRAWINGS

FIGS. 1A-1D show various views generally showing a tensioning assembly in accordance with one embodiment disclosed herein.

FIGS. 2A-2D show the tensioning assembly of FIGS. 1A-1D having a rotational knob removed to show a gear assembly of the tensioning assembly.

FIG. 3 is a side view showing a worm gear of the gear assembly having a core and a thread design.

FIGS. 3A-3B shows the thread design and the core separated out from the worm gear.

FIG. 4 shows an example of a variable pitch thread pattern of the thread design.

FIGS. 5A-5C show various arrangements of a gear train in accordance with various embodiments of the tensioning assembly.

FIGS. 6A-6D show various views of a manual tensioning assembly having the gear assembly disposed within a housing in accordance with another embodiment disclosed herein.

FIGS. 7A-7C show various views of a motor driven tensioning assembly having the gear assembly disposed within a housing in accordance with another embodiment disclosed herein.

FIGS. 8A-8B show various views of a motor driven tensioning assembly having the gear assembly disposed within a housing in accordance with still another embodiment disclosed herein.

### DETAILED DESCRIPTION

Exemplary embodiments will now be described with references to the accompanying figures, wherein like reference numbers refer to like elements throughout. The terminology used in the description presented herein in not intended to be interpreted in any limited or restrictive manner simply because it is being utilized in conjunction with a detailed description of certain embodiments. Furthermore, various embodiments (whether or not specifically described herein) may include novel features, no single one of which is solely responsible for its desirable attributes or which is essential to practicing any of the embodiments herein described.

The present disclosure relates generally to a tensioning assembly, and more particularly to a tensioning assembly having, among other things, a relatively more efficient, adjustable, and compact gear assembly.

As used herein, the term “hub” is intended to include a spindle, a spool, a sheave, or a similar type article(s) that is configured or may be adapted to permit rotation of the hub to facilitate tensioning of a “line” used for the purpose of applying tension to secure a “load”.

As used herein, the term “line” is intended to include a rope (round synthetic, natural fiber, metal), a cable, a cord, a flat line (webbing), an anchor line or tensioning line, or a similar type of article(s) that may be adapted to be used with the tensioning assembly disclosed herein for the purpose of applying tension to secure a “load”.

As used herein, the term“load” or “cargo” is intended to include any item or items that are generally secured to prevent movement of the item(s) while in a static position, or while being moved or transport from one position to another position.

The tensioning assembly described herein provides, among other things, a relatively more efficient, adjustable, and compact gear assembly (a relatively small “footprint”), for manual or motorized tensioning of a line to secure a load.

Various parts, elements, components, etc, of the tensioning assembly disclosed herein may be constructed from metal, plastic, composite, or other suitable material or combination thereof for providing a rigid and sturdy structure to facilitate tensioning of a line for the purpose of securing a load.

The actual size and dimension of any and all of the various parts, elements, components, etc., may vary depending on various factors including, among other things, intending application or usage of the tensioning assembly, as well as the size of the load to be secured or prevented from moving while in a static position, or while being moved or transport from one position to another position.

Connection(s) between the various parts, elements, components, etc., of the tensioning assembly may be accomplished using a variety of methods or processes. As such, the connections, whether integral and created via bending, or form molding, for example, or connected via bonding, hardware (nuts, bolts, washers, etc.), welding, or similar techniques, are well known in the art and omitted for simplicity.

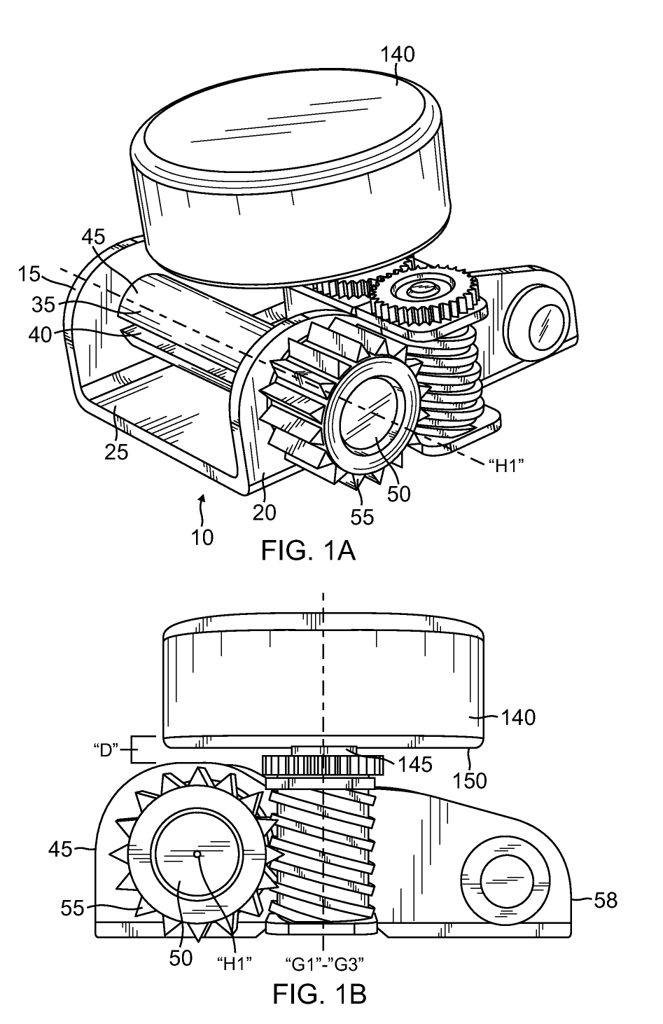

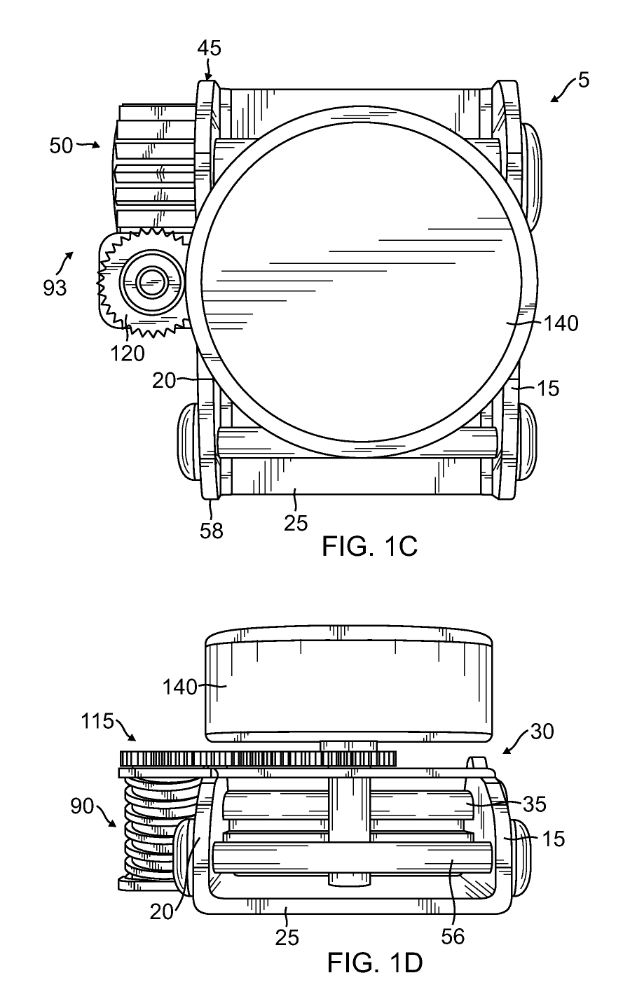

FIGS. 1A-1D show various views generally showing a tensioning assembly in accordance with one embodiment disclosed herein. The tensioning assembly 5 includes a frame 10 having a first sidewall 15, a second sidewall 20, and a base or botton 25 disposed between and connected the first sidewall 15 and the second sidewall 20. The first sidewall 15 and the second sidewall 20 are connected to the base 25 along opposite edges of the base 25, and extend upright from the base 25 and parallel to each other to form a generally elongeated U-shaped trough 30 (FIG. 1D). A generally cylindrical hub or spindle 35 having a slot 40 formed therein for receiving a first line 42 therethrough is disposed between the first sidewall 15 and second sidewall 20 along a first end 45 of the frame 10. The hub 35 operatively connects through the second sidewall 20 of the frame 10 to a generally circular gear 50 having a plurality of teeth 55 formed around the circumference of the gear 50 and projecting outwardly thereform. The hub 35 and gear 50 are rotatable about a first axis of rotation “H1”.

A terminal or anchor post 56 is disposed between the first sidewall 15 and the second sidewall 20 along a second end 58 of the frame 10 opposite the first end 45 of the frame 10. In this embodiment, the anchor post 56 is configured to receive an end of a second line around the anchor post 56. An end of the second line opposite the end that is around the anchor post 56 may be connected a hook to secure the second end. In another embodiment, the second line may be thread through a device similar to that which is commonly used on book bags to take up the slack of the second line and secure the line in the device.

In still another embodiment, the need for the second line or anchor post 56 may be eliminated as a terminal hook, clamp, or similar device may be interchangeably attached to the second end 58 or integral formed by welding, bolting, or similar means with the second end 58 of the frame 10 of the tensioning assembly 5. In this regard, the second end 58 may be configured to interchangeable accept or permanently accept a device to secure the second end 58 of the tensioning device 5.

As disclosed herein, with the second line of the anchor post 56 secured to a first point, the first line 42 secured to a second point, and the tensioning assembly 5 place about a load, rotation of the hub 35 in one direction wraps the first line 42 around the hub 35 to apply a tension to the first line and second line and secure the load in place.

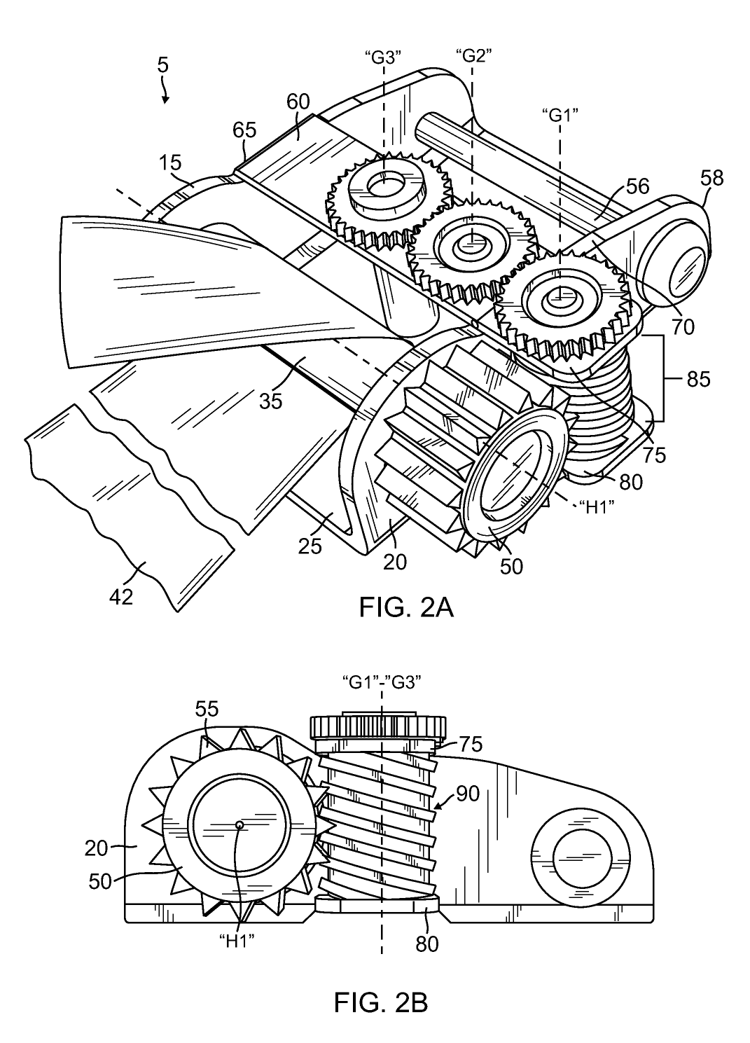

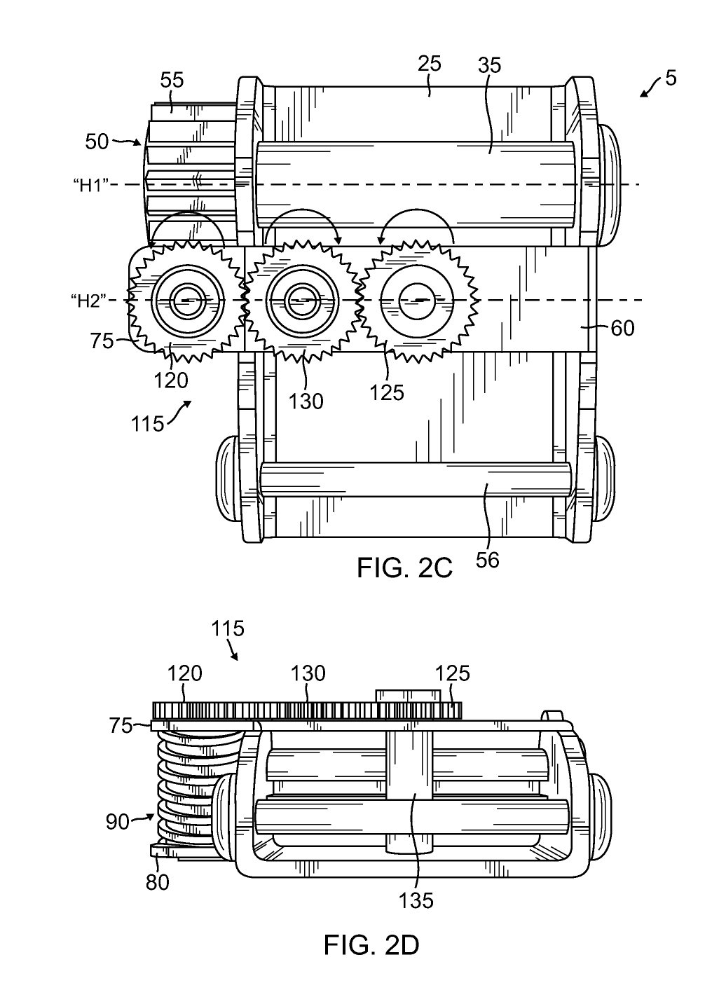

As best shown in FIGS. 2A-2D, the tensioning assembly 5 further includes a bridge 60 extending across the U-shaped trough 30 of the frame 10 along an axis “H2” that is parallel to the first axis of rotation “H1” to connect an upper edge 65 of the first sidewall 15 and an oppositely formed upper edge 70 of the second sidewall 20. The bridge 60 extends outward from the second sidewall 20 to form an upper ledge 75. A lower ledge 80 is connected to the base 25 and extends outward from the second sidewall 20. In this regard, the upper ledge 75 and the lower ledge 80 are spaced apart and parallel with each other, extend outward in the same direction from the second sidewall 20, and have a similar shape to define a space 85 therebetween for containing and permitting rotational movement of a worm gear 90 along a second axis of rotation “G1” that is generally perpendicular to the first axis of rotation “H1” of the hub 10 and the corresponding gear 50.

The gear 50 and the worm gear 90 together form a bi-directional rotation gear assembly or simply a gear assembly 93. As disclosed herein, the gear assembly 93, that is, the gear or first drive gear 50 and the worm gear or second gear drive 90 are just one example of bi-directional rotation gear assemblies that transfer rotational movement from the second axis of rotation “G1” to the first axis of rotation “H1”. Other examples of bi-directional rotation gear assemblies that may be used in the tensioning assembly 5 disclosed herein include, but are not limited to a straight bevel gear assembly, a spiral bevel gear assembly, a hypoid gear assembly, and other bi-directional rotation gear assemblies used in differentials, gear boxes, transmissions and similar structures, but on a smaller scale.

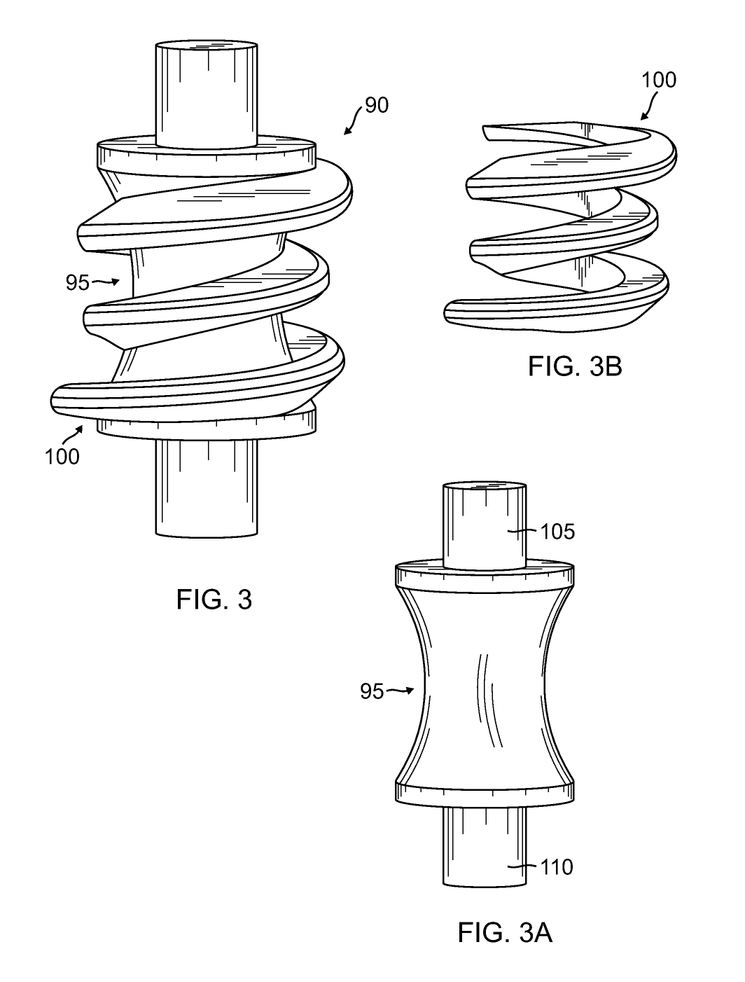

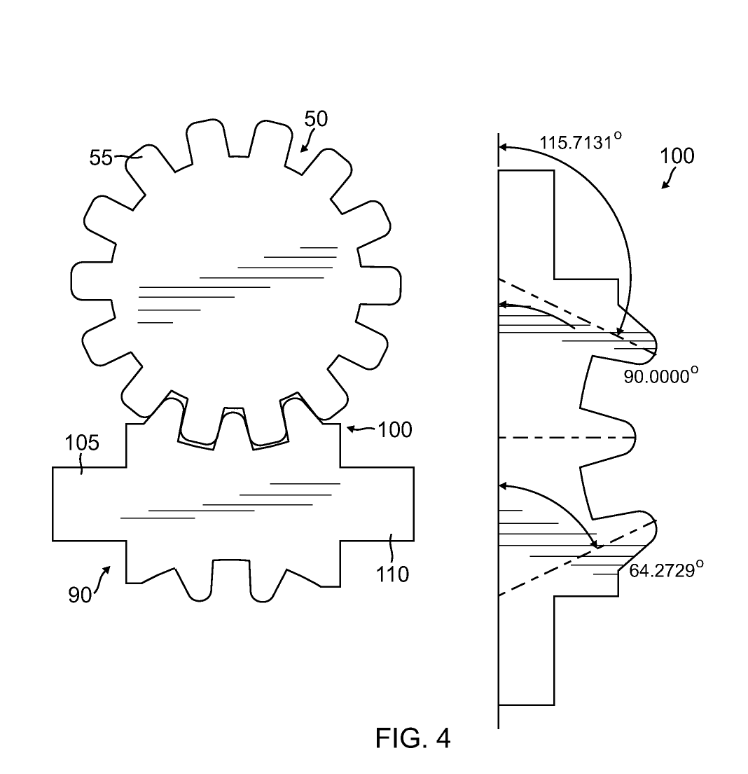

FIG. 3 is a side view showing the worm gear 90 including a core 95 and a thread design 100. In this regard, as indicated above, the worm gear 90 including the core 95 and the thread design 100 may be formed as a single integral piece by injection or form molding or similar technique, or the core 95 and the thread design 100 may be formed as separate elements and joined as in bonding with an adhesive or similar technique. As shown in FIG. 3A, in one embodiment, the core 95 is catenoidal in shape and includes a first post 105 that connects to the upper ledge 75, and a second post 110 that connects to the lower edge 80.

Persons of ordinary skill in the art will understand that the orientation of the core 95, that is, the first post 105 and the second post 110 and the respective connection to the upper ledge 75 or lower ledge 80 may be reversed within the scope of the disclosure. As shown in FIG. 3B, in one embodiment, the thread design 100 includes a continuous variable pitch thread.

As shown in FIG. 4, the gear 50 is operatively connected to the worm gear 90. More specifically, the teeth 55 of the gear 50 are configured or adapted (sized, spaced, and pitched) to correspondingly engage with the thread design 100 formed on the core 95 of the worm gear 90 such that rotation of the worm gear 90 about the second axis of rotation “G1” produces a corresponding rotation of the gear 50 and the hub 35 about the first axis of rotation “H1”. The thread design 100 formed on the catenoidal shape of the core 95 allows a relatively greater surface area of engagement between the thread design 100 of the core 90 and the gear 50 to generally increase the amount of rotational tension applied to the hub 35.

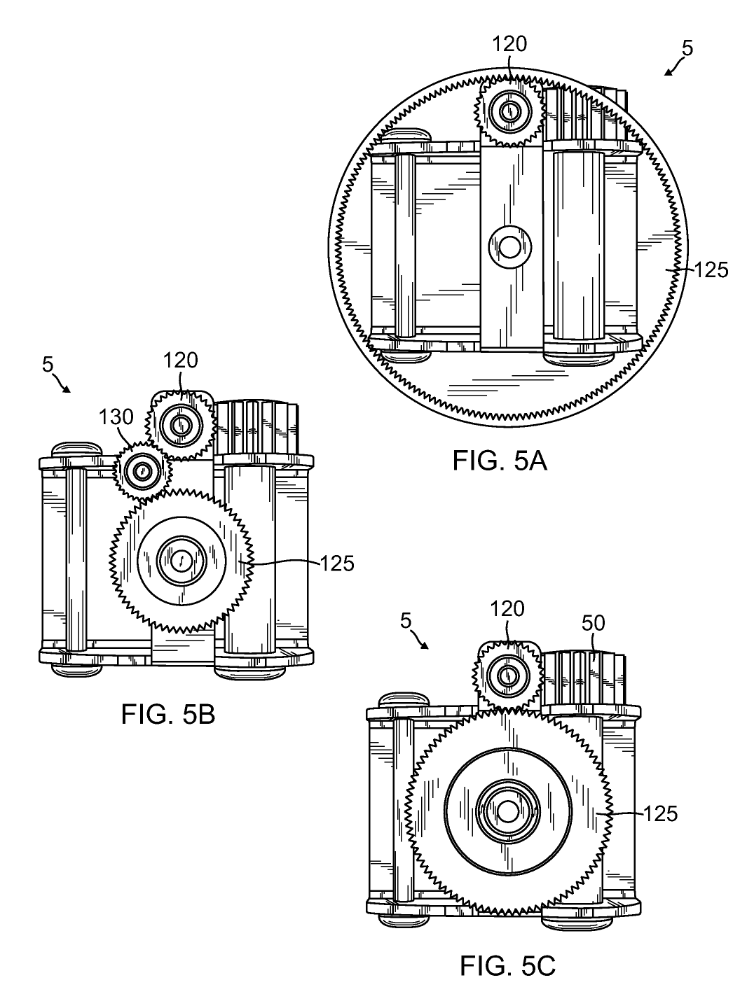

Returning specifically to FIG. 2C, in one embodiment, the bridge 60 of the tensioning assembly 5 is configured or adapted (sized, shaped, and contructed) to receive thereon a gear train 115 including a first gear 120, a second gear 125, and a third gear 130. In this regard, the first gear 120, the second gear 125, and the third gear 130 are aligned along axis “H2” and are operatively connected to each other along the bridge 60 by the engagement of corresponding teeth extending from each of the gears 120, 125, 130 such that rotation of any of the first gear 120, the second gear 125, or the third gear 130 will rotate the other gears. Although the gears 120, 125, 130 are shown as being substantially the same size, as shown in FIG. 5B, the size of one or more of the gears 120, 125, 130 may be increased or decreased relative to the size of the other gears to provide a mechanical advantage (different torque, rotational speed, gear ratio, etc.). Likewise, although the gear train 115 is shown with three gears, as shown in FIG. 5C, the gear train 115 may include two gears, or more than three gears appropriately sized for a correspondingly sized tensioning assembly. As shown in FIG. 5A, the gear train 115 includes the first gear 120 disposed within an inner circumference and operatively connect to the second gear. In this regard, the second gear 125 may be formed circumferentially along an inner side the handle 140 with the handle 140 having a post connected to the bridge 60 for rotation of the handle 140.

In the embodiment shown in FIG. 2A, the first gear 120 is positioned on the upper ledge 75 and is operatively connected through the upper ledge 75 to engage and rotate the worm gear 90. The second gear 125 is positioned along the bridge 60 at an approximate midpoint between the first sidewall 15 and the second sidewall 20 that forms a portion of the U-shaped trough 30. The third gear 130 is positioned between the first gear 120 and the second gear 125.

As best shown in FIG. 2A, the first gear 120 rotates about the second axis of rotation “G1”, the second gear 125 rotates about a third axis of rotation “G2”, and the third gear rotates about a fourth axis of rotation “G3”. The second axis of rotation “G1”, the third axis of rotation “G2”, and the fourth axis of rotation “G3” are parallel with each other.

Accordingly, upon rotation of either of the first gear 120, the second gear 125, or the third gear 130, the hub 35 is caused to rotate as the hub 35 is operatively connected to the worm gear 90, which in turn is operatively connected to the gear train 115.

In contrast to the audiable clicking heard when applying tension to a ratchet assembly, rotation of the gear train 115 is smooth and substantially silent. In this regard, the tensioning assembly 5 disclosed herein is particularly advantageous for police, military, or tactical applications where stealth and silent operation is desirable. As shown in FIG. 2D, an optional post 135 may be positioned beneath the second gear 125 and between the bridge 60 and the base 25 for support and structural integrity of the tensioning assembly 5.

As shown in FIGS. 1A-1D, the tensioning assembly 5 includes a rotational knob or handle 140 configured or adapted to be removably attachable and operatively connectable to either the first gear 120, the second gear 125, or the third gear 130. Rotation of the handle 140 upon connection of the handle 140 to either of the first gear 120, the second gear 125, or the third gear 130 produces a corresponding rotation in the gear train 115, the gear 50, and a corresponding rotation of the hub 35.

As shown in FIG. 1B, the handle 140 includes a spacer 145 to space a bottom 150 of the handle 140 a distance “D” from the gear train 115. Generally, the distance “D” between the bottom 150 of the handle 140 and the gear train 115 provides adequte clearance to account for the take-up of the first line about the hub 35 during tensioning and securing of a load. Alternatively, the handle 140 may be configured or adapted to include an adjustable height post or a separate riser (not shown) with the tensioning assembly 5 to adjust the position of the bottom 150 of the handle 140 relative the gear train 115.

As indicated above, the tensioning assembly 5 described herein provides, among other things, a relatively more efficient, adjustable, and compact gear assembly (a relatively small “footprint”). In this regard, positioning of the handle 140 on the second gear 125 provides a relatively small “footprint” for the entire tensioning assembly 5. In this regard, as best shown in FIG. 1C, in one embodiment, the handle 140 is contained almost entirely between the first sidewall 15 and the second sidewall 20.

Rotational torque to the handle 140 positioned at an approximate midpoint between the first sidewall 15 and the second sidewall 20 provides for a relatively more balanced and stable structure when compared to the back-and-forth handle movement associated with the ratchet assembly that tends to drive the entire ratchet assembly up and down.

Adjustability of the tensioning assembly 5, that is, the ability to remove, attach, and operatively connect the handle 140 to either the first gear 120, the second gear 125, or the third gear 130, permits rotation of the handle 140 and tensioning of the lines attached to the tensioning assembly 5 to secure a load even in relatively tight spaces. That is, if placement of the tensiong assembly 5 on the second gear 125 does not permit adequate access to the handle 140 and sufficient torque to be applied due to space limitation along the first sidewall 15, the handle 140 may be removed from the second gear 125 and operatively connected to either the first gear 120 or the third gear 130.

The tensioning assembly 5 disclosed herein applies a bi-directional rotational force to the hub 35 in both the take up (rotational tensioning) and release (de-tensioning) direction without the tension “back off” normally experienced with ratchet type mechanisms. Accordingly, in one embodiment, a dedicated locking mechanism to prevent release of the tension once the load is secured in not required. In this regard, reverse rotation or rotation of the handle 140 in a direction opposite to the direction used to tension the lines and secure the load may be utilized to release the tension and unsecure the load.

In another embodiment (not shown), the handle 140, gear train 115, and bridge 60 may be correspondingly configured or adapted to permit the handle 140 to function as a locking mechanism to lock the gear train 115 in place after application of tension is induced in the lines to secure the load. In this regard, the handle 140, one or more gears 120, 125, 130 of the gear train 115, and the bridge 60 may include a “lock and key” structure having protrusions and corresponding recesses that permit, for example, protrusions of the handle 140 to engage recesses of the gear to permit rotation of the gear train 115 by the handle 140 when the handle 140 is in an up or raised position. After tension is applied to the lines by rotation of the gear train 115, the handle 140 is placed in a down or lowered position to engage protrusions formed on the handle 140 with recesses formed on each of the gear and the bridge 60 to prohibit rotation of the gear train 115, essentially locking the gear train 115 in place with tension applied.

Another benefit of the tensioning assembly 5 is that a precise amount of tension can be applied to the tensioning assembly 5 disclosed herein with relatively greater control, either to increase or decrease tension in smaller amounts in the tensioning assembly 5 not attainable by either the cam buckle or the ratchet style devices. As explain in greater detail below, the fine control of tension could interface with a standard force gauge to indicate the applied manual or motorized force in real-time, and in any unit of measure.

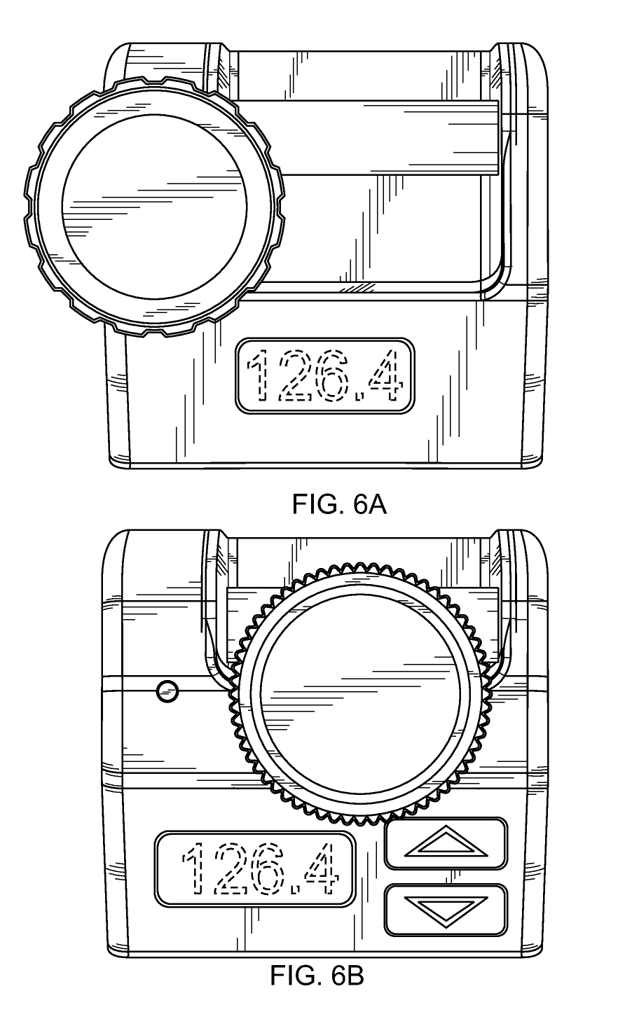

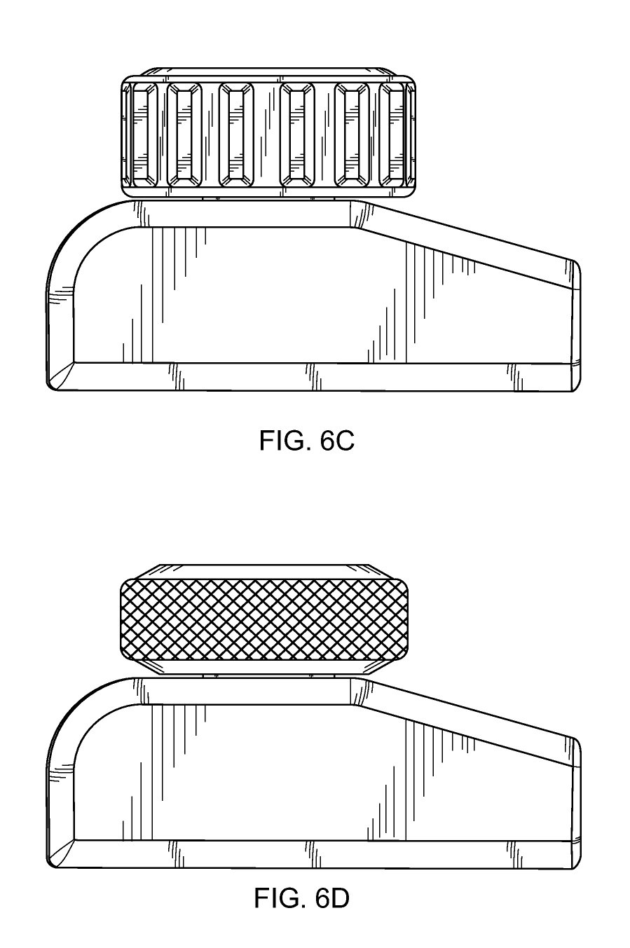

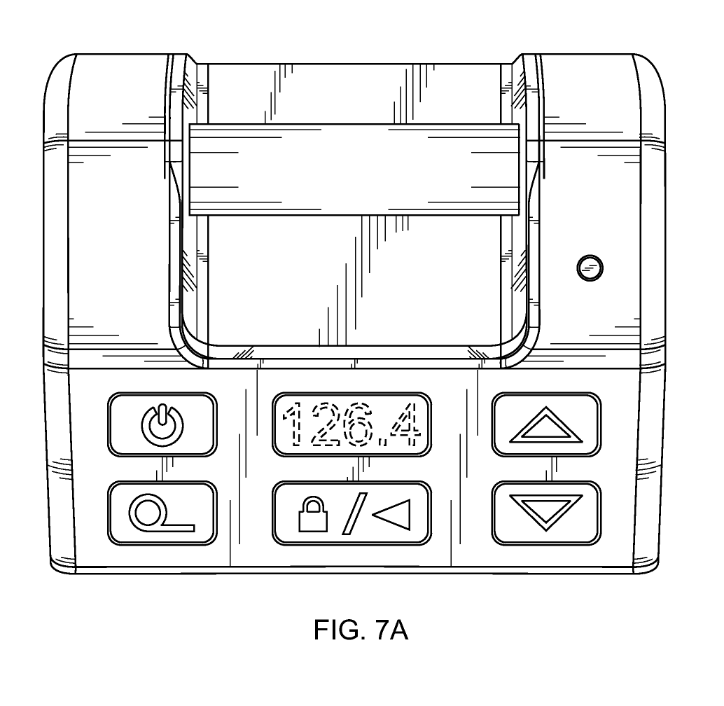

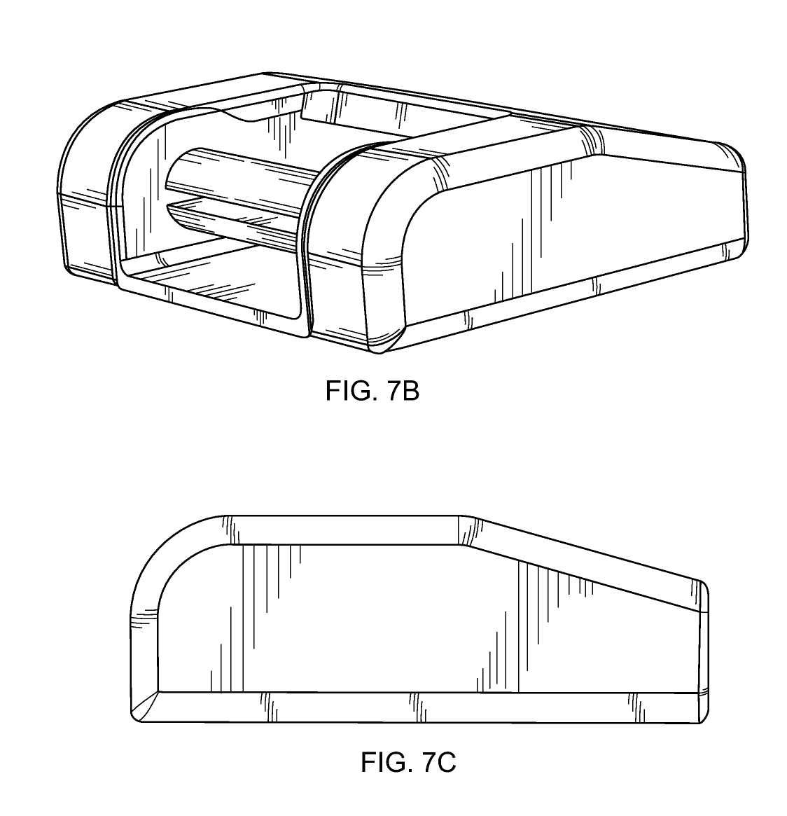

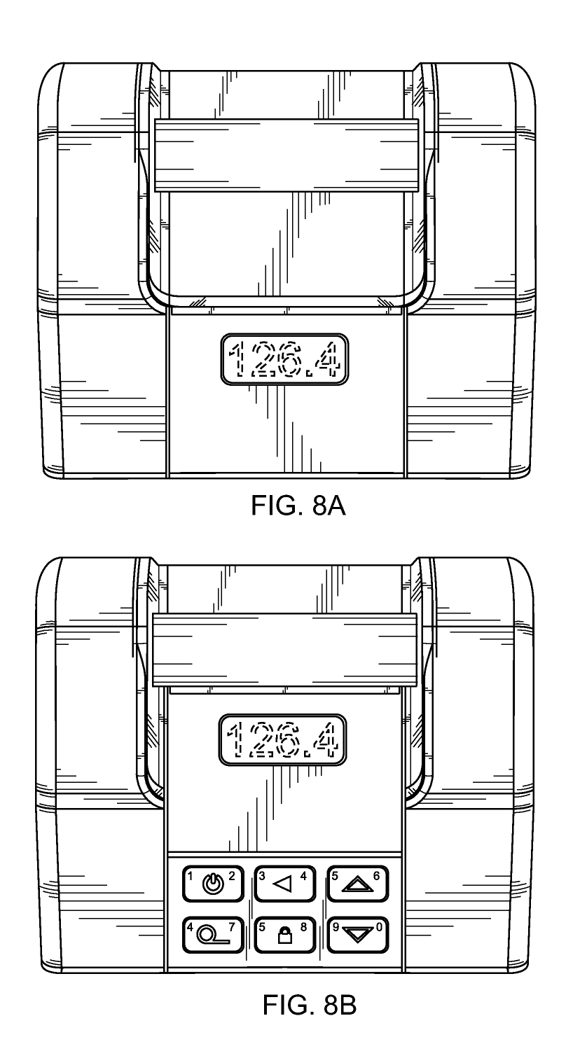

FIGS. 6A-6D, show various views of a manual tensioning assembly having the gear assembly disposed within a housing in accordance with another embodiment disclosed herein, FIGS. 7A-7C show various views of a motor driven tensioning assembly having the gear assembly disposed within a housing in accordance with another embodiment disclosed herein, and FIGS. 8A-8B show various views of a motor driven tensioning assembly having the gear assembly disposed within a housing in accordance with still another embodiment disclosed herein.

As shown in the aforementioned figures, the tensioning assembly may be combined with an electronic interface to signal or warn of a change in tension, either a loss or an increase in tension. The electronic interface may be enabled via blue tooth or other wireless technology and configured to communicate one of a programmed alert message, a sound or an alarm, activate a strobe or other beacon to another device to visually (LED) and audibly indicate a change in a defined parameter (tension imposed on the tensioning device). In this regard, the interface may provide a read out of a measure of strain imposed on the tensioning assembly. A loss of tension may be attributed to component level assembly failure, anchor point failure, or an unauthorized removal of tension making the tensioning device not only an apparatus and method to secure cargo and prevent unwanted shifting of the cargo, but to also an apparatus and method to serve as a theft deterrent. The electronic interface may include a miniature load cell with force gauge technology and a digital display to allow input of parameters regarding assembly tension.

A further embodiment of the tensioning assembly may include a motor or similar device that allows for an automated motorized tension operation with electronic interface for preprogramming load tension, time (duration of tensioning), spool out speed/time, spool up speed/time, and my include a programmed security code to enable functionality, thus functioning as an automatic tensioning assembly with defined operational parameters/characteristics and as an anti-theft system. The interface may be realized in a mobile device such as a smart phone, PDA, computer, or similar device that would permit input via the interface to communicate the various aforementioned operational parameters to the tensioning assembly and receive load tension parameters from the tensioning assembly.

A method or process of tensioning a load with the tensioning assembly 5 typically includes securing a first line to a relatively stable, secure, or stationary object; passing the line over, around, about, etc. a load that is intended to be secured; and passing the first line through the slot 40 formed in the hub 35 of the tensioning assembly 5. Securing the second line attached to the anchor post 56 of the tensioning assembly 5 to another relatively, stable, secure, or stationary object. Removing excess slack that may be present in the first line and second line by pulling an end of the first line so that the first line is pulled taut through the slot 40 of the hub 35. Rotating the handle 140 of the tensioning assembly 5 in one direction to rotate the drive train 115, the worm gear 90, the gear 50, and the hub 35 to wrap the first line around the hub 35 to apply a tension to the first line and second line and secure the load in place.

Releasing the tension that was placed on the first line and the second line and unsecuring the load is accomplished by rotating the handle 140 in an opposite direction to the direction of rotation used to apply tension to the first line and second line and secure the load.

As such, the subject matter disclosed herein provides for an improved tensioning assembly having, among other things, a relatively more efficient, adjustable, and compact gear assembly.

Although the method(s)/step(s) are illustrated and described herein as occurring in a certain order, the specific order, or any combination or interpretation of the order, is not required. Obvious modifications will make themselves apparent to those skilled in the art, all of which will not depart from the essence of the disclosed subject matter, and all such changes and modifications are intended to be encompassed within the appended claims.

What is claimed is:

1. A tensioning assembly comprising,
a worm gear having a core and a thread design formed on the core, wherein the core has a catenoidal shape.

2. The tensioning assembly of claim 1, wherein the thread design is a continuous variable pitch thread.

3. The tensioning assembly of claim 2, wherein the thread design and core are integrally formed as a single piece.

4. The tensioning assembly of claim 1, further comprising,
a rotatable hub;
a gear connected to rotate with the rotatable hub and operatively connected to the worm gear.

5. The tensioning assembly of claim 4, wherein the hub and gear are rotatable about a first axis of rotation and the worm gear is rotatable about a second axis of rotation.

6. The tensioning assembly of claim 5, wherein the first axis of rotation is perpendicular to the second axis of rotation.

7. The tensioning assembly of claim 1, further comprising a handle connected to the worm gear to rotate the worm gear.

8. The tensioning assembly of claim 4, further comprising a gear train including a plurality of gears operatively connected to the worm gear, wherein upon rotation of the gear train the hub rotates.

9. The tensioning assembly of claim 8, further comprising a handle removably attachable and operatively connectable to any of the plurality of gears of the gear train to rotate the gear train.

10. The tensioning assembly of claim 8, wherein the plurality of gears are sized and positioned to provide a mechanical advantage.

11. A tensioning assembly comprising,
a frame having a first end and a second end opposite the first end; and
a strap connected to the first end,
wherein the second end is configured to interchangeable accept a device to secure the second end.

12. The tensioning assembly of claim 11, wherein the device to secure the second end is one of a hook or clamp connected directly to the second end.

13. The tensioning assembly of claim 11, where the device to secure the second end is integrally formed with second end.

14. The tensioning assembly of claim 11, further comprising,
a worm gear having a core and a thread design formed on the core, wherein the core has a catenoidal shape.

15. The tensioning assembly of claim 14, wherein the thread design is a continuous variable pitch thread.

16. The tensioning assembly of claim 15, wherein the thread design and core are integrally formed as a single piece.

17. The tensioning assembly of claim 14, further comprising a strain gauge for read out of a measure of strain imposed on the tensioning assembly.

18. The tensioning assembly of claim 14, further comprising a housing having the worm gear disposed therein, wherein the housing includes an interface to signal a change in tension imposed on the tensioning assembly.

19. The tensioning assembly of claim 18, wherein the interface is wirelessly enabled and configured to communicate one of a programmed alert message, a sound or an alarm, activate a strobe or other beacon to another device to visually or audibly indicate a change in the tension imposed on the tensioning assembly.

20. A method of tensioning a line of a tension assembly, the method comprising:
receiving the line within a hub of the tension assembly, the hub operatively connected to a gear and rotatable along a first axis of rotation;
operatively connecting a worm gear to the gear, the worm gear rotatably about a second axis of rotation;
operatively connecting a gear train to the worm gear; and
rotating the gear train to rotate the hub and apply tension to the line.
